(19) United States
(12) Patent Application Publication
(10) Pub. No.: US 2016/0340837 A1
(43) Pub. Date: Nov. 24, 2016

(54) APPLICATION OF A RANDOM-LAID WEB FOR ROADWAY CONSTRUCTION WITH IMPROVED ADHESION PROPERTIES

(71) Applicant: SIKA TECHNOLOGY AG, Baar (CH)

(72) Inventor: Herbert ACKERMANN, Tann (CH)

(73) Assignee: SIKA TECHNOLOGY AG, Baar (CH)

(21) Appl. No.: 15/157,988

(22) Filed: May 18, 2016

(30) Foreign Application Priority Data
May 20, 2015 (EP) 15168523.7

(51) Int. Cl. E01C 7/18; E01C 19/00; E01C 7/20; E01C 7/35; C09J 123/08; C09D 195/00

(52) U.S. Cl. CPC E01C 7/185; C09J 123/0853; C09J 123/0869; C09D 195/00; E01C 7/20; E01C 7/353; E01C 19/00

(57) ABSTRACT

A method for producing a roadway construction, including the steps of applying a random-laid web composed of an adhesive composition which includes at least one solid epoxy resin and at least one thermoplastic polymer solid at room temperature to a substrate including a bearing structure, preferably a concrete structure, and applying a bitumen-based bearing course. The method permits rapid and efficient production of a roadway construction with improved adhesion of asphalt to the substrate. To some extent, primer pretreatment of surfaces is no longer needed.

The present invention relates to a method for producing a roadway construction, comprising the steps of: applying a random-laid web composed of an adhesive composition which comprises at least one solid epoxy resin and at least one thermoplastic polymer solid at room temperature to a substrate comprising a bearing structure, preferably a concrete structure, and applying a bitumen-based bearing course.

The method permits rapid and efficient production of a roadway construction with improved adhesion of asphalt to the substrate. To some extent, primer pretreatment of surfaces is no longer needed.

### TECHNICAL FIELD

The invention pertains to the field of the sealing of roadways on a substrate comprising a bearing structure.

### PRIOR ART

Roadways which are applied to a substrate with a bearing structure, more particularly to a concrete bearing structure, are frequently encountered, especially in the form of bridges. Concrete bearing structures of this kind are sealed off typically with bitumen sheeting. A topmost course applied in road-building is customarily a bitumen-based bearing course. A problem which arises here, however, is that there must be an effective adhesive bond between the bearing course and the substrate material, for example a metal or concrete bearing structure, possibly with a seal located thereon, this of course including the adhesion of all of the intermediate courses. The adhesion between substrate and further courses on the substrate with bitumen-based bearing course, in particular, is a problem which is very difficult to solve here, owing to the materials involved.

One approach at solving this problem is to use poured asphalt as a bonding agent between a polymeric substrate course and the bitumen-based bearing course. The great disadvantage of these systems, however, is that first of all the poured asphalt must be applied at high temperature and the bitumen-based bearing course can be applied only after cooling; one consequence of this, owing to this additional step, is to increase the length and cost of production of the sealing operation, or production operation, of the roadway. It has emerged, moreover, that roadways of this kind, owing to the high axle weights of the vehicles utilizing the roadway, undergo detachment and deformation and lead to unwanted damage to the roadway covering within short times.

WO 2008/095 215 A1 gets round the problem by using a concrete roadway, describing a concrete roadway on a concrete bearing structure with a liquid-polymeric film situated between them, and also with an adhesive course between liquid-polymeric film and concrete roadway. In order to ensure the adhesion of the concrete roadway with the adhesive course, a proposal in that case is to intersperse silica sand into the adhesive course before its hardening.

EP 2 282 948 A1 describes a method for producing a roadway construction, said construction connecting a liquid-polymeric film on a bearing structure to the bitumen-based bearing course by means of an adhesive composition. This adhesive composition is used in forms including that of granules.

Where granules are used, one of the difficulties is that of uniform metering. Furthermore, it is generally necessary for the granules to be embedded into a primer—requiring additional application—in order to prevent loss of material by wind drifts.

### PRESENTATION OF THE INVENTION

It is an object of the present invention, therefore, to provide a method for producing a roadway construction that can be produced easily and rationally and that leads to an effective adhesive bond between a substrate, comprising a bearing structure, and a bitumen-based bearing course. The intention, further, is that it shall be possible to avoid additional surface treatments and to avoid waiting times between the application of the individual courses. At the same time, it ought to be possible to improve metering of the adhesive composition and for fastening to be easy.

At the core of the present invention is the application of a random-laid web composed of an adhesive composition which comprises at least one solid epoxy resin and at least one thermoplastic polymer solid at room temperature. Surprisingly it has emerged, accordingly, that this problem can be solved by a method according to claim 1 and by a roadway construction according to claim 14.

Relative to the prior art, a roadway construction of this kind is easier to construct as a system and also entails a shorter waiting time. A further advantage of the method of the invention is that it is easy to apply a defined amount of the adhesive composition, thereby enabling very uniform metering to be achieved. Furthermore, under windy conditions, drifts are avoided and application on gradients can be done without material running off. Additionally, the random-laid web can also be attached to the substrate in an easy way by mechanical fastening, if desired.

In one preferred embodiment, the random-laid web may be formed on the construction side, or on site, directly on the substrate by extrusion. The web is applied at above its melting temperature, thus acting as a hotmelt adhesive, and developing adhesion to the substrate. In this way, the random-laid web may be applied immediately prior to application of the bitumen-based bearing course, with the extrusion apparatus ideally being integrated into the asphalt application machine, allowing both courses to be formed practically in one operation. In this way it is possible to shorten significantly the otherwise customary waiting times between the production of the individual courses.

In another preferred embodiment, the method further comprises the applying of a primer and of a liquid-polymeric film to the bearing structure to form the substrate. The random-laid web can then be applied to the liquid-polymeric film, and a polymeric primer can be applied as adhesion promoter to the film before the random-laid web is applied, in order to allow a bond. It is, however and surprisingly, also possible for the random-laid web to be applied directly to the liquid-polymeric film, without the application of a polymeric primer beforehand.

If a primer is not necessary for embedding the random-laid web, the consequence is a significant reduction in costs and in time, the latter since there is no need to wait for a primer to cure.

Another aspect of the invention is the use of the random-laid web as adhesive bond material between the substrate and the bitumen-based bearing course. Particularly preferred embodiments of the invention are subjects of the dependent claims.

### WAYS OF PERFORMING THE INVENTION

The present invention relates in a first aspect to a method for producing a roadway construction, comprising the steps of
(i) applying a random-laid web composed of an adhesive composition which comprises at least one solid epoxy resin and at least one thermoplastic polymer solid at room temperature to a substrate comprising a bearing structure, preferably a concrete structure; and
(ii) applying a bitumen-based bearing course.

The bearing structure is preferably a structure of overground or underground construction. More particularly it may be a bridge, a gallery, a tunnel, an entry or exit ramp, or a parking deck. A preferred example of a bearing structure of this kind is a bridge. This bearing structure, which is necessary for the roadway, is a structure made from a material which may have a load-bearing function. This material more particularly is a metal or a metal alloy or a concrete, more particularly reinforced concrete, preferably ferroconcrete.

The most preferred example of such a bearing structure is a concrete bridge.

Primers are known to the person skilled in the art. A “primer” in this document is understood in general to be a thin layer of a polymer composition which is applied to a substrate and which enhances the adhesion between that substrate and another substrate. A primer has fluid consistency at room temperature and is applied to the substrate by spreading, painting, rolling, spraying, pouring or brushing. It should be noted here that the term “fluid” refers not merely to liquid materials but also to more highly viscous, honeylike to pastelike, materials, the shape of which is adapted under the influence of gravity.

“Room temperature” refers in this document to a temperature of 23° C.

“Concrete primer” in this document refers to a thin layer of a primer applied to the concrete that enhances the adhesion of concrete to another substrate. Preferred concrete primers are epoxy resin-based primers. More particularly they are two-part epoxy resin primers, in which one component (i.e. first part) comprises an epoxy resin, more particularly an epoxy resin based on bisphenol A diglycidyl ether, and the other component (i.e. second part) comprises a curing agent, more particularly a polyamine or a polymercaptan. Considered particularly preferred are epoxy resin primers which have no fillers. Advantageously, moreover, the concrete primers are highly fluid, more particularly having a viscosity of below 10 000 mPas, preferably between 10 and 1000 mPas, at 23° C., allowing them to penetrate into the concrete surface. Particularly preferred concrete primers are two-part, highly fluid epoxy resin primers of the kind sold under the commercial range name Sikafloor® or Sikagard® by Sika Deutschland GmbH or Sika Schweiz AG. Particularly preferred concrete primers are Sikafloor® 156 primer and Sikagard® 186.

Particularly preferred concrete primers are polyurea primers, especially two-part polyurea primers. These are, more particularly, two-part, fast-curing, solvent-containing primers which feature a long pot life and can be reworked under ideal conditions after 30 minutes. A result of using these primers is a further time advantage. One example is Sika® Concrete Primer from Sika Schweiz AG.

For other materials there are respectively appropriate primers—for metal, metal primers, more particularly for steel, steel primers, of the kind known to the person skilled in the art.

A “polymeric primer” for the purposes of this document is a thin layer of a primer which is applied to the liquid-polymeric film and which enhances the adhesion of liquid polymeric film to another substrate. The polymeric primer may be, for example, a polyurethane primer or an epoxy primer. Preferred polymeric primers are epoxy resin-based primers. Particularly preferred polymeric primers are also the aforementioned polyurea primers.

In one preferred embodiment, the substrate further comprises a primer layer on the bearing structure and optionally a liquid-polymeric film applied to the primed bearing structure. More preferably the substrate comprises a primer layer on the bearing structure and a liquid-polymeric film applied to the primed bearing structure.

In a preferred embodiment of the method for producing a roadway construction in accordance with the present invention, the method, prior to the application of the random-laid web, therefore comprises the following steps for forming the substrate, preference being given to the performance of both steps:
(i′) applying a primer to the bearing structure, preferably applying a concrete primer to a concrete structure or applying a metal primer to metal, more particularly steel; and optionally
(i″) applying a liquid-polymeric film to the bearing structure primed according to step (i′).

It is preferred, moreover, if inorganic interspersants, more particularly sand, preferably silica sand, are interspersed into the primer, preferably into the concrete primer or metal primer, between step (i′) and step (i″), where performed. In order to ensure an effective bond between interspersant and primer, more particularly concrete primer or metal primer, it is advantageous if this interspersant is interspersed before the primer hardens.

It is preferred for this inorganic interspersant to have a maximum particle size of less than 1 mm, more particularly between 0.1 and 1 mm, preferably between 0.3 and 0.8 mm. The amount of such interspersants, however, should be made such that the primer is not covered over its entire area, but instead such that within the construction there are always locations where the primer is in direct contact with the polymeric film.

It has been found that the use of interspersant is advantageous for the bond between liquid-polymeric film and primer, or the bearing structure. Possible explanations for this, though without subjecting the invention to any limitation, are that there is at least a partial flow of primer around the particle surface, thus creating a greater contact area between liquid-polymeric film and primer, and/or that the inorganic interspersants bring about strong local reinforcement of the primer layer, hence allowing greater forces to be transmitted, or absorbed, between liquid-polymeric film and bearing structure, and/or that as a result of the interspersants there is a purely mechanical anchorage between liquid-polymeric film and primer, with the particles incorporated into the primer matrix resulting in a roughened primer surface and with these particles being embedded into the surface of the preferably elastic liquid-polymeric film. In the case of a liquid-polymeric film produced on site, produced more particularly by means of a spraying process, the liquid-polymeric film acquires a significantly greater contact surface area, since it is applied to a primer surface which has a significantly greater surface area owing to the roughening caused by the interspersants.

With regard to the thickness of the primer layer it is clear to the person skilled in the art that this thickness is of course dependent not only on the surface roughness of the bearing structure but also on whether interspersants are being used or not. The average thickness of the primer layer is typically between 100 micrometres and 10 millimetres; advantageously, the average thickness of the primer layer is below 3 mm, preferably between 0.1 and 2 mm.

Subsequently, in the preferred embodiment, in a step (i″), a liquid-polymeric film is applied to the bearing structure primed according to step (i′).

For maximum suitability as liquid-polymeric film, the liquid-polymeric film must be watertight and also must not suffer decomposition or mechanical damage under prolonged influence of water, or of moisture.

Examples of suitable liquid-polymeric films are films of the kind as already used for sealing, particularly for roof construction or for bridge sealing, in the prior art. Liquid-polymeric films are, more particularly, one- or multi-component materials which are applied in liquid form in situ and which react and/or solidify to form a film or seal.

The polymeric film ought advantageously to have at least a small extent of elasticity, allowing them, for example, to bridge differences in expansion between asphalt and bearing structure, caused by temperatures, or stresses caused by cracks in the bearing structure or in the bearing course, without damage to or tearing of the liquid-polymeric film and without any adverse effect on the sealing function of the liquid-polymeric film.

Particularly preferred are liquid polymeric films based on polyurethanes or polyureas or poly(meth)-acrylates or epoxy resins, which can be used preferably as two-part products to form the liquid-polymeric film on site.

The liquid-polymeric film is produced in particular on site, for example by a crosslinking reaction of reactive components which are mixed and applied on site. Application may take place mechanically or by hand, for example by pouring, spreading or spraying. Liquid-polymeric films of this kind are based generally on two-part products and are also known as liquid polymeric seals.

Of greatest preference as liquid-polymeric film or liquid polymeric seal are films or seals based on polyurethane, polyurea or epoxy resin, which are formed in particular from two-part products. Particularly preferred are sprayed liquid polymeric films of two-part polyurethanes and, in particular, liquid-polymeric films of two-part polyurea.

The liquid-polymeric film advantageously has a layer thickness in the millimetre range, typically between 0.5 and 15 mm, preferably between 1 and 4 mm.

In accordance with the invention a random-laid web composed of an adhesive composition is applied to the substrate. The adhesive composition comprises at least one solid epoxy resin and at least one thermoplastic polymer solid at room temperature.

The term “solid epoxy resin” is very well known to the person skilled in the epoxy art, and is used in contrast to “liquid epoxy resin”. The glass transition temperature of solid resins is above room temperature, meaning that they can be comminuted at room temperature to give free-flowing powders.

Preferred solid epoxy resins have the formula (I)

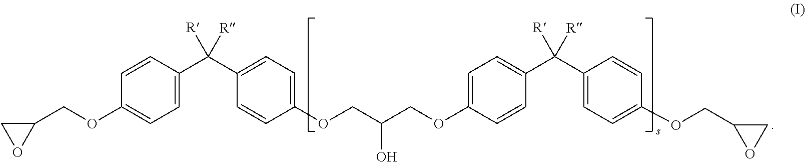

In this formula the substituents R′ and R″ independently of one another are either H or CH₃. Furthermore, the index s is a value of >1.5, more particularly of 2 to 12.

Solid epoxy resins of this kind are available commercially, for example under the trade range name D.E.R.™ or Araldite® or Epikote from Dow or Huntsman or Hexion, respectively, and accordingly are very well known to the person skilled in the art.

Compounds of the formula (I) having an index s of between 1 and 1.5 are referred to by the person skilled in the art as semi-solid epoxy resins. For the purposes of the present invention they are likewise considered to be solid resins. Preferred, however, are epoxy resins in the narrower sense, i.e. where the index s has a value of >1.5.

The thermoplastic polymer solid at room temperature is in particular a polymer which is solid at room temperature, and which at a temperature above the softening temperature softens and ultimately becomes fluid.

In this document, softening temperatures or softening points are understood in particular to be those measured by the ring & ball method in accordance with DIN ISO 4625.

It is very advantageous if the thermoplastic polymer solid at room temperature has a softening point in the range from 50° C. to 150° C., more particularly from 90° C. to 130° C. Particularly preferred thermoplastic polymers are those having a softening point which is at least 25° C. below the temperature of the bitumen-based bearing course as measured on application in step (ii).

Suitable thermoplastic polymers solid at room temperature are, in particular, homopolymers or copolymers of at least one olefinically unsaturated monomer, more particularly of monomers selected from the group consisting of ethylene, propylene, butylene, butadiene, isoprene, acrylonitrile, vinyl esters, especially vinyl acetate, vinyl ethers, allyl ethers, (meth)acrylic acid, (meth)acrylic esters, maleic acid, maleic anhydride, maleic esters, fumaric acid, fumaric esters and styrene.

The copolymer may be formed from two, three or more different monomers. Particularly suitable copolymers are those prepared only from the monomers of the group recited above.

Also particularly suitable are copolymers of olefinically unsaturated monomers that have been modified by grafting reaction, more particularly the copolymers in the preceding section that are modified by grafting reaction.

Examples of the thermoplastic polymer solid at room temperature are polyolefins, more particularly poly-α-olefins. Of greatest preference are atactic poly-α-olefins (APAO).

Preferred solid thermoplastic polymers are ethylene/vinyl acetate copolymers (EVA), especially those having a vinyl acetate fraction of below 50 wt %, more particularly having a vinyl acetate fraction of between 10 and 40 wt %, preferably between 20 and 35 wt %, most preferably between 27 and 32 wt %.

It is particularly preferred, furthermore, for the at least one thermoplastic polymer solid at room temperature to be a terpolymer of ethylene, acrylic ester, e.g. ethyl acrylate, and maleic anhydride.

It has proved to be particularly preferred if at least two different thermoplastic polymers solid at room temperature are used, which preferably have a different chemical composition. One of these two different thermoplastic polymers, most preferably, is an ethylene/vinyl acetate copolymer.

It is advantageous, moreover, if the other thermoplastic polymer is a copolymer prepared using maleic acid or maleic anhydride as monomer or as grafting reagent.

The weight ratio of solid epoxy resin to thermoplastic polymer solid at room temperature in the adhesive composition is preferably between 1:2 and 1:25, more preferably between 1:4 and 1:20.

It has proved to be preferred, moreover, if the adhesive composition further comprises at least one tackifier resin, more particularly based on hydrocarbon resins, preferably on aliphatic hydrocarbon resins, more particularly of the kind sold for example by Exxon Mobil under the trade name Escorez™.

It has proved to be particularly advantageous if the adhesive composition further comprises at least one chemical or physical blowing agent.

These blowing agents may be exothermic blowing agents, such as azo compounds, hydrazine derivatives, semicarbazides or tetrazoles, for example. Preferred blowing agents are azodicarbonamide and oxybis(benzene-sulphonylhydrazide). On decomposition, these blowing agents release energy. Also preferred, furthermore, are endothermic blowing agents, such as sodium bicarbonate or sodium bicarbonate/citric acid mixtures, for example. Chemical blowing agents of these kinds are available for example under the name Celogen™ from Chemtura. Likewise suitable are physical blowing agents, of the kind sold under the trade name Expancel™ by Akzo Nobel.

Particularly suitable blowing agents are those as available under the trade name Expancel™ from Akzo Nobel or Celogen™ from Chemtura.

Preferred blowing agents are chemical blowing agents which release a gas on heating, more particularly to a temperature of 100 to 160° C.

The amount of the physical or chemical blowing agent is situated in particular in the range of 0-3 wt %, preferably in the range from 0.2 to 2 wt % and more preferably in the range from 0.5 to 1.5 wt %, based on the weight of the adhesive composition.

The adhesive composition may further optionally comprise at least one epoxide crosslinking catalyst and/or at least one curing agent for epoxy resins. However, this is not preferred. They are activated by elevated temperature. The epoxide crosslinking catalysts and/or curing agents for epoxy resins are preferably selected from dicyandiamide, guanamines, guanidines, aminoguanidines and derivatives thereof; substituted ureas, especially 3-(3-chloro-4-methyl-phenyl)-1,1-dimethylurea (chlorotoluron), or phenyl-dimethylureas, more particularly p-chlorophenyl-N,N-dimethylurea (monuron), 3-phenyl-1,1-dimethylurea (fenuron), 3,4-dichlorophenyl-N,N-dimethylurea (diuron), N,N-dimethylurea, N-isobutyl-N′,N′-dimethylurea, 1,1′-(hexane-1,6-diyl)bis(3,3′-dimethylurea), and also imidazoles, imidazole salts, imidazolines and amine complexes. These heat-activatable curing agents are activatable preferably at a temperature of 80-160° C., more particularly of 85° C. to 150° C., preferably of 90-140° C. Dicyandiamide in combination with a substituted urea is used in particular.

The adhesive composition may optionally further comprise additional constituents, examples being biocides, stabilizers, especially heat stabilizers, plasticizers, pigments, adhesion promoters, especially organosilanes, reactive binders, solvents, rheological modifiers, fillers or fibres, especially glass, carbon, cellulose, cotton or synthetic polymer fibres, preferably fibres of polyester or of a homopolymer or copolymer of ethylene and/or propylene, or of viscose.

The adhesive composition in accordance with the invention is applied in the form of a random-laid web to the substrate. Random-laid webs are known to the person skilled in the art. The random-laid web is a laid web of one or more strands of the adhesive composition that are arranged in a sheet-like formation in an irregular pattern. The strands may overlap themselves and/or other strands. The strands are preferably continuous strands.

The random-laid web is produced preferably by an extrusion process, with the adhesive composition being melted in an extruder and extruded through one or more extrusion heads onto a surface, for example a conveyor belt or on site directly onto the substrate as outlined below, extrusion taking place for example by means of a suitable scheme of movement of the extrusion head or heads and/or of the surface on which the strands are deposited, and/or by variations in the extrusion pressure, causing the extruded strand or strands to be laid down as a random-laid web on the surface.

The extruder preferably has one or more, for example 1 to 4, rows of extrusion heads lying one above another. The number of extrusion heads and strands for the random-laid web is dependent, for example, on the width of the random-laid web to be formed; the number, however, may for example be at least 10, e.g. 10 to 400, preferably 100 to 300, per m of random-laid web width.

The cross section of the strands may be arbitrary, for example triangular, rectangular, circular or oval, preference being given generally to a circular cross section. The diameter of the strands may be for example in the range from 0.5 mm to 4 mm, preferably from 1.0 mm to 2.0 mm.

The thickness of the random-laid web may be for example in the range from 0.3 mm to 20 mm, preferably from 1.0 mm to 5.0 mm.

The application rate of the random-laid web composed of an adhesive composition to the substrate is preferably 200 to 2000 g/m², more preferably 400 to 1500 g/m², and very preferably 500 to 1000 g/m².

The basis weight of the random-laid web is preferably from 0.2 to 2.0 kg/m² and more preferably from 0.5 to 1.0 kg/m².

In one preferred embodiment the adhesive composition is extruded on site or on the construction side, and the extruded strand or strands are laid onto the substrate in order to form the random-laid web; in other words, the random-laid web is formed directly on the building site on the substrate. For this purpose, the adhesive composition may be supplied, for example, in the form of pellets and melted as elucidated above in an extruder on site, and extruded directly onto the substrate in order to form the random-laid web. In this way it is easy for a defined amount of the adhesive composition to be applied.

As a result of the formation of the random-laid web on site, directly on the substrate, the strands are in the molten state or still-hot state on application to the substrate, thus producing an advantageous adhesive bond to the substrate. This is particularly advantageous if the random-laid web is applied directly to the bearing structure, i.e. without primer between the bearing structure and the random-laid web.

The random-laid web may alternatively have been prefabricated. Production is likewise by extrusion, as elucidated above for the on-site production, except that the extruded strands, rather than being extruded directly onto the substrate, are extruded onto a conveyor belt, for example, in a production plant. In this way a sheet of the random-laid web is produced, and can be supplied for example in the form of rolls. There is no need for the random-laid web to be supported, by an underlay or sheet, for example. The width of the rolls may be for example up to 3 m. The prefabricated roll or sheet may be laid onto the substrate on site. This ensures ready meterability. As and when required, the random-laid web may be fastened to the substrate, preferably mechanically by means of an adhesive tape.

The random-laid web is applied to the substrate, it being possible here for the random-laid web to be applied, for example, to the bearing structure, to the primed bearing structure, or to the liquid-polymeric film of the substrate.

In a first preferred embodiment, the random-laid web is applied directly to the bearing structure or to a primed bearing structure, preference being given to direct application of the random-laid web to the bearing structure, i.e. without the use of a primer between substrate and random-laid web. Direct application to the bearing structure is especially preferable when the random-laid web is being formed on site directly on the bearing structure by extrusion and laying of the extruded strand or strands.

In a further preferred embodiment, the random-laid web is applied to a substrate, the substrate comprising a liquid-polymeric film on a primed bearing structure. The method for forming this substrate has already been elucidated above. In this embodiment, the random-laid web is applied to the liquid-polymeric film.

It is preferred in this case for a polymeric primer to be applied to the liquid-polymeric film and for the random-laid web to be applied to the primer within the open time of the polymeric primer. Examples of suitable polymeric primers are polyurethane, polyurea or epoxy primers, preferably epoxy primers, with the primer being one-part or preferably two-part in form.

The open time is the time within which the applied polymeric primer is still liquid or tacky, i.e. the primer has not yet cured.

In a further preferred embodiment, the random-laid web is applied to the liquid-polymeric film without a primer being applied beforehand to the liquid-polymeric film. With this embodiment, the random-laid web may optionally be fixed on the liquid-polymeric film by mechanical fastening, more particularly with an adhesive tape, by welding, or by heating, with a hot air blower, for example. Mechanical fastening is advantageous. It leads to an advantageous adhesive bond between the liquid-polymeric film and the bitumen-based bearing course, and results in an additional cost and time advantage, the reasons including there being no need to wait for the primer to cure. The adhesive composition has very good adhesive-bonding properties in the molten or partially melted state, and so fixing by heating is readily possible.

In step (ii), finally, a bitumen-based bearing course is applied. With preference the bitumen-based bearing course is applied directly to the random-laid web, preferably immediately after application of the random-laid web.

It is particularly advantageous if this bitumen-based bearing course is applied directly to the random-laid web composed of the adhesive composition. When a bitumen-based bearing course is applied, the random-laid web is partially melted and hence sufficient adhesion between the two is ensured.

It is preferred, furthermore, for the bitumen-based bearing course to be applied immediately after application of the random-laid web. This can be achieved, for example, by integrating the extrusion apparatus for applying the random-laid web in the asphalt production machine for applying the bitumen-based bearing course. In this way, the two courses can be applied in a single operation. Waiting times can be avoided.

The bitumen-based bearing course constitutes the roadway, which is in direct contact with vehicles. Melted asphalt or rolled asphalt may serve preferably as the bitumen-based bearing course. Rolled asphalt used may include asphalt concrete or chippings-and-mastic asphalt; melted asphalt used may include asphalt mastic. If the bitumen-based bearing course or the bituminous bearing course is made from rolled asphalt, it is heated, for example, prior to application to a temperature of typically 140° C. to 160° C. and applied preferably by roller.

The use of melted asphalt and rolled asphalt as road coverings, floor coverings, or for seals is very well known to the person skilled in the art.

Particularly suitable types of asphalt are those types having a mixed-material temperature in the range from 100 to 240° C. The types of asphalt for preferred use in the present invention are hot mix asphalt (HMA), warm mix asphalt (WMA), half warm mix asphalt and cold mix asphalt.

The application of the bituminous bearing course is very well known to the person skilled in the art and will therefore not be discussed in any more detail here.

In addition to bitumen, the bearing course may have further possible constituents known to the person skilled in the art. The person skilled in the art knows the nature and amount of the constituents of bitumen-based compositions that are used for producing roadways very well. Particularly important here is the fact that the bearing course customarily has, to a significant extent, mineral fillers, more particularly sand or chippings.

When the melted bitumen makes contact with the random-laid web composed of the adhesive composition, the thermoplastic polymer solid at room temperature melts, along with any other meltable components of the random-laid web, the melting being complete or partial depending on their melting point. On melting, the random-laid web may form a largely homogeneous thermoplastic layer or may dissolve in the bitumen close to the surface and form a thermoplastic-containing boundary phase course. In the case of the method of the invention, therefore, it is also possible for the random-laid web composed of the adhesive composition not to form a discrete or individual course.

If the random-laid web composed of the adhesive composition has a chemical or physical blowing agent, contact between the melted bitumen and the random-laid web activates the blowing agent, in particular with release of gas, resulting in an additional improvement in adhesion.

It is also considered advantageous that the solid epoxy resin can undergo crosslinking at elevated temperature, even on its own, but especially under the influence of epoxide crosslinking catalysts and/or curing agents for epoxy resins and/or compounds having anhydride groups.

The random-laid web preferably forms an adhesive bond between a liquid-polymeric film and the bearing course or between the bearing structure, which is made preferably of concrete, metal, more particularly steel, or is a bitumen-based structure, and the bearing course. In one preferred embodiment the bearing structure is of metal, more particularly steel, or concrete.

One particularly preferred embodiment of the method comprises the steps of
(i) applying the random-laid web directly to the bearing structure, preferably a concrete structure, with the adhesive composition being extruded on site and with the extruded strand or strands being laid onto the substrate to form the random-laid web, and
(ii) applying the bitumen-based bearing course directly to the random-laid web, preferably immediately after application of the random-laid web.

This direct application of the random-laid web to the bearing structure takes place in particular without prior application of a primer to the bearing structure. The bitumen-based bearing course is preferably applied immediately after application of the random-laid web.

Another particularly preferred embodiment of the method comprises the steps of
(i′) applying a primer to the bearing structure, preferably applying a concrete primer to a concrete structure or applying a metal primer to metal, more particularly steel;
(i″) applying a liquid-polymeric film to the bearing structure primed according to step (i′),
(i) applying the random-laid web to the liquid-polymeric film, and
(ii) applying a bitumen-based bearing course.

In the case of this particularly preferred embodiment, the bearing structure is more particularly a bridge, more preferably a bridge of concrete or of metal, especially steel.

The liquid-polymeric film which is applied to the primed bearing structure of metal, more particularly steel, is preferably an epoxy resin-based liquid-polymeric film, more particularly a two-part epoxy resin-based liquid polymeric film. The liquid polymeric film used may be, for example, SikaCor® HM Mastic from Sika Deutschland GmbH or Sika Schweiz AG.

Suitable with particular preference as primers for application to a bearing structure made from metal, more particularly steel, are anti-corrosion primers.

For the application of the random-laid web to the liquid-polymeric film, it is possible either for a plastics primer to be applied to the liquid-polymeric film and for the random-laid web to be applied to the plastics primer within the open time of the plastics primer, or for the random-laid web to be applied to the liquid-polymeric film without a polymeric primer being applied beforehand to the liquid polymeric film.

A further aspect of the present invention relates to the roadway construction obtained by the method of the invention.

The present invention lastly includes the use of the random-laid web as adhesive bonding material between a substrate and a bitumen-based bearing course.

The roadway construction produced in this way exhibits durable bonding among the individual courses and layers, the resulting assembly having long-term dimensional stability even under high axle weights. Fatigue cracks therefore form much less quickly; such cracks could adversely affect the sealing function of the roadway construction. The use of the random-laid web, moreover, avoids otherwise-necessary pretreatment of surfaces and produces improved adhesion. In one preferred embodiment, moreover, the use of a primer on a bearing structure or on a liquid-polymeric film located on a substrate is avoided, with a consequent considerable saving in terms of cost and time.

### BRIEF DESCRIPTION OF THE DRAWING

The drawings are used below to illustrate working examples of the invention. Identical elements in the various figures are given the same reference symbols.

In the drawings:

FIG. 1 shows a cross section through a roadway construction of the invention;

FIG. 2 shows a cross section through a further roadway construction of the invention;

FIG. 3 shows a cross section through a further roadway construction of the invention;

FIG. 4 shows the production of a random-laid web by extrusion;

FIG. 5 shows a plan view of the extrusion heads used in the extrusion process;

FIG. 6 shows the random-laid web, applied to a substrate.

The drawings are diagrammatic. Only those elements essential to a direct understanding of the invention are shown.

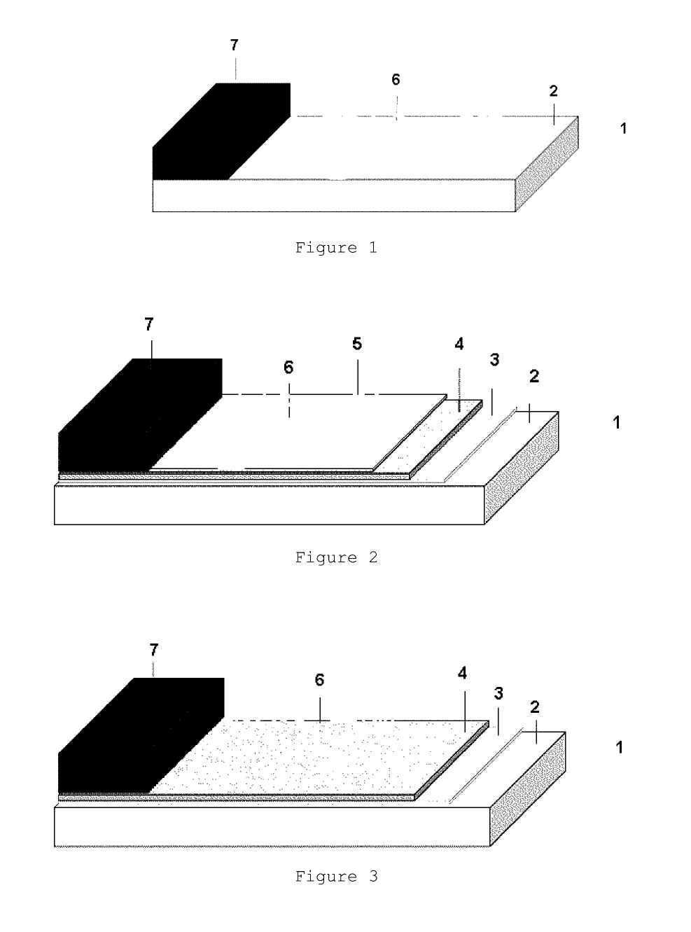

FIG. 1 shows a diagrammatic cross section through a preferred roadway construction 1, with a random-laid web composed of the adhesive composition 6 being applied on a bearing structure 2, preferably a concrete bearing structure, and with a bitumen-based bearing course 7 being applied over the random-laid web.

FIG. 2 shows a diagrammatic cross section through a further preferred roadway construction 1, in which a primer/concrete primer 3 is applied on a bearing structure 2, preferably a concrete bearing structure. Located atop this system is a liquid-polymeric film 4, to which a polymeric primer 5 and, subsequently, the random-laid web composed of an adhesive composition 6 have been applied. Applied over the random-laid web is a bitumen-based bearing course 7.

FIG. 3 shows a diagrammatic cross section through a roadway construction according to FIG. 2, without a polymeric primer 5 on the liquid-polymeric film. The random-laid web, accordingly, is applied directly on the liquid-polymeric film. In this preferred embodiment, the random-laid web composed of an adhesive composition may optionally be fixed for example by mechanical fastening with an adhesive tape or by welding or heating to the liquid-polymeric film.

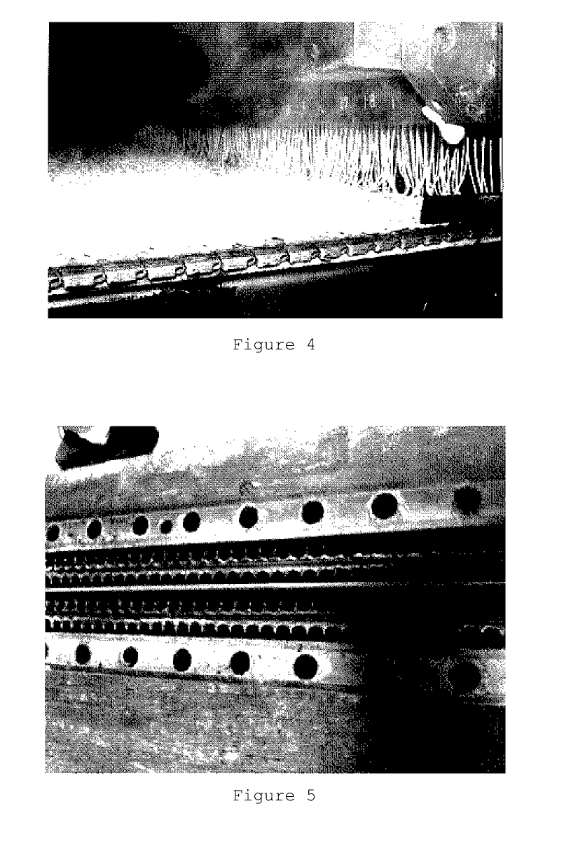

FIG. 4 shows the production of the random-laid web by extrusion of the adhesive composition and laying of the extruded strands onto a conveyor belt.

FIG. 5 shows a plan view of the extrusion heads for extruding the random-laid web.

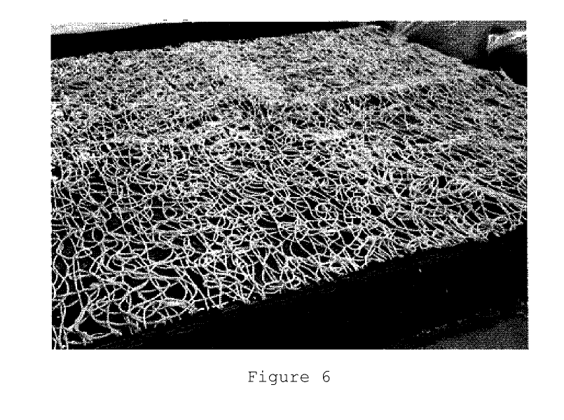

FIG. 6 shows the random-laid web applied to a substrate.

### LIST OF REFERENCE SYMBOLS

1 roadway construction
2 bearing structure, preferably concrete bearing structure or metal bearing structure
3 primer, preferably concrete primer or metal primer
4 liquid-polymeric film
5 polymeric primer
6 random-laid web composed of adhesive composition
7 bitumen-based bearing course

### EXAMPLES

An adhesive composition was produced with the ingredients identified in table 1 in the proportions specified there.

TABLE 1

| | | Parts |
|---|---|---|
| | | by wt. |
| EVA | Ethylene/vinyl acetate copolymer | 25.0 |
| | (vinyl acetate content 28 wt %, | |
| | softening temperature (ring & ball | |
| | method as per DIN ISO 4625): 106° C. | |
| MAM-EVA | Maleic anhydride-grafted ethylene/ | 23.4 |
| | vinyl acetate copolymer (maleic | |
| | anhydride fraction: 0.2-0.4 wt %) | |
| Araldite ® | Solid epoxy resin | 4.0 |
| Hydrocarbon | Tackifier resin | 10.0 |
| resin | | |
| Chalk | Filler | 36.8 |
| Sodium | Blowing agent | 0.8 |
| bicarbonate | | |

To produce the adhesive composition, the ingredients were mixed with one another in a twin-screw extruder at a temperature of 80-120° C. Subsequent granulation formed pellets having a diameter of approximately 1 to 3 mm.

The pellets were extruded to form a random-laid web composed of the adhesive composition. FIG. 3 shows the random-laid web applied to the substrate with the liquid-polymeric film/seal (4). The diameter of the strands was 1 to 2 mm.

### Examples 1 to 3

### Ex. 1-3

As a model of a roadway construction and for the testing of the mechanical values, three concrete slabs measuring 50×50×6 cm were each coated with Sikafloor® 161 (primer based on 2-part epoxy resin, available from Sika Schweiz AG) as concrete primer in an amount of 0.3 to 0.4 kg/m². The primer was applied to the concrete structure with a felt roller. After an evaporation time of 12 hours, Sikalastic® 851 (2-part, solvent-free, fast-curing polyurethane) was sprayed on mechanically using a 2-component high-pressure spraying unit, to give a liquid-polymeric film (film thickness about 2.0 mm). Subsequently, after a waiting time of 2 hours, Sikafloor® 161 (primer based on 2-part epoxy resin, available from Sika Schweiz AG) was applied by felt roller as a polymeric primer in an amount of 0.4 kg/m².

The random-laid web composed of the adhesive composition as described above was then applied in an amount of 0.73 kg/m² to the polymeric primer, which was still tacky. After a waiting time of 24 hours, a rolled asphalt AC T 16 N 70/100 heated to 160° C. was applied in two operations, in an amount of 0.8 to 1.0 kg/m², to give a layer thickness in each case of 4 cm, and was rolled in.

### Reference Examples 1 to 3

### Ref. 1-3

The production of the models of a roadway construction was repeated with three concrete slabs as per examples 1 to 3, but with the adhesive composition applied not in the form of a random-laid web but instead in the form of pellets, likewise in an amount of 0.73 kg/m² to the polymeric primer which was still tacky.

### Evaluation

After cooling, the models as per examples 1 to 3 and as per reference examples 1 to 3 were tested after one day for the strength in N/mm² in accordance with standard EN 13596 and for the shear strength (“SF”) in accordance with standard EN 13653, and the fracture mode obtained was assessed visually. In all cases, fracture was always found either within the asphalt layer (close to the boundary) or in the boundary phase between the adhesive composition and the asphalt. The results obtained accordingly are summarized in tables 2 and 3 below.

TABLE 2
Test results for the strength in [N/mm²].

| | Ref. 1 | Ref. 2 | Ref. 3 | Ex. 1 | Ex. 2 | Ex. 3 |
|---|---|---|---|---|---|---|
| Area [mm²] | 2496 | 2756 | 2862 | 2756 | 2703 | 2600 |
| Temperature | 20.8 | 20.8 | 20.8 | 20.8 | 20.8 | 20.8 |
| [° C.] | | | | | | |
| Breaking | 1.44 | 2.55 | 2.74 | 2.76 | 2.72 | 2.36 |
| load [kN] | | | | | | |
| Strength | 0.57 | 0.93 | 0.96 | 1.00 | 1.01 | 0.91 |
| [N/mm²] | | | | | | |
| Proportion | 90 | 90 | 90 | 90 | 90 | 100 |
| of cohesive | | | | | | |
| fracture³ | | | | | | |
| [%] | | | | | | |
| Proportion | 10 | 10 | 10 | 10 | 10 | 0 |
| of adhesive | | | | | | |
| fracture⁴ | | | | | | |
| [%] | | | | | | |

³Cohesive fracture within the rolled asphalt
⁴Adhesive fracture between rolled asphalt and adhesive composition

TABLE 3
Test results for the strength in [N/mm²].

| | Ref. 1 | Ref. 2 | Ref. 3 | Ex. 1 | Ex. 2 | Ex. 3 |
|---|---|---|---|---|---|---|
| Area [mm²] | 25194 | 24860 | 24420 | 24200 | 24420 | 24090 |
| Shear | 0.80 | 0.99 | 0.91 | 0.94 | 1.16 | 1.02 |
| stress [N/mm²] | | | | | | |
| Proportion | 100 | 100 | 100 | 100 | 95 | 90 |
| of cohesive | | | | | | |
| fracture³ | | | | | | |
| [%] | | | | | | |
| Proportion | 0 | 0 | 0 | 0 | 5 | 10 |
| of adhesive | | | | | | |
| fracture⁴ | | | | | | |
| [%] | | | | | | |

³Cohesive fracture within the rolled asphalt
⁴Adhesive fracture between rolled asphalt and adhesive composition

The results show that the adhesive values obtained with the random-laid web are at least the same as those achieved with the pellets. The advantage of the random-laid web, furthermore, is in particular that a consistent quantity per m² and hence constant adhesive values over the entire area can be guaranteed.

### Example 4

An adhesive composition was produced with the ingredients identified in table 4 in the proportions specified there.

TABLE 4

| | | wt % |
|---|---|---|
| Ester | Terpolymer of ethylene, acrylic ester | 33.20 |
| | and maleic anhydride | |
| Hydrocarbon | Tackifier resin | 10.00 |
| resin | | |
| Chalk | Filler | 54.40 |
| Araldite | Epoxy resin | 2.00 |
| OBSH | Blowing agent | 0.40 |
| | | 100.00 |

From the composition, pellets and a random-laid web were produced as for the composition described in table 1. Examples 1-3 and reference examples 1-3 were repeated analogously, using the composition of table 4 rather than the composition of table 1. Evaluation took place in the same way as for the composition of table 1, and the results obtained were similar.

1. Method for producing a roadway construction, comprising the steps of
(i) applying a random-laid web composed of an adhesive composition which comprises at least one solid epoxy resin and at least one thermoplastic polymer solid at room temperature to a substrate comprising a bearing structure, and
(ii) applying a bitumen-based bearing course.

2. Method according to claim 1, wherein the adhesive composition is extruded on site and the extruded strand or strands are laid onto the substrate to form the random-laid web.

3. Method according to claim 1 wherein the bitumen-based bearing course is applied directly to the random-laid web.

4. Method according to claim 1, wherein the random-laid web is applied directly to the bearing structure.

5. Method according to claim 1, the method further comprising, prior to the application of the random-laid web, the following steps for forming the substrate:
(i′) applying a primer to the bearing structure, and
(i″) applying a liquid-polymeric film to the bearing structure primed according to step (i′).

6. Method according to claim 5, wherein a polymeric primer is applied to the liquid-polymeric film, and the random-laid web is applied within the open time of the polymeric primer to the liquid-polymeric primer.

7. Method according to claim 5, wherein the random-laid web is applied to the liquid-polymeric film without a polymeric primer being applied beforehand to the liquid-polymeric film.

8. Method according to claim 7, wherein the random-laid web is fixed on the liquid-polymeric film by mechanical fastening.

9. Method according to claim 1, wherein the random-laid web is formed by extrusion.

10. Method according to claim 1, wherein the thermoplastic polymer solid at room temperature is an ethylene/vinyl acetate copolymer or an ethylene-acrylic ester-maleic anhydride terpolymer and/or in that the at least one thermoplastic polymer solid at room temperature has a softening point in the range from 50° C. to 150° C.

11. Method according to claim 1, wherein the weight ratio of solid epoxy resin to thermoplastic polymer solid at room temperature in the adhesive composition is between 1:2 and 1:25.

12. Method according to claim 1, wherein the adhesive composition comprises a chemical or physical blowing agent.

13. Method according to claim 1, wherein the random-laid web forms the adhesive bond between the liquid-polymeric film and the bearing course or between the bearing structure and the bearing course.

14. Roadway construction obtainable by a method according to claim 1.

15. A random-laid web composed of an adhesive composition which comprises at least one solid epoxy resin and at least one thermoplastic polymer solid at room temperature as adhesive bond material between a substrate and a bitumen-based bearing course.
